(19) United States
(12) Patent Application Publication
(10) Pub. No.: US 2010/0070397 A1
(43) Pub. Date: Mar. 18, 2010

(54) RESOURCE-ALLOCATION PROCESSING SYSTEM AND APPROACH WITH RESOURCE POOLING

(76) Inventors: Dean W. Hahn-Carlson, Lilydale, MN (US); Richard G. Langer, Lakeville, MN (US)

Correspondence Address: CRAWFORD MAUNU PLLC, 1150 NORTHLAND DRIVE, SUITE 100, ST. PAUL, MN, 55120, US

(21) Appl. No.: 12/506,949

(22) Filed: Jul. 21, 2009

Related U.S. Application Data
(60) Provisional application No. 61/082,433, filed on Jul. 21, 2008.

(51) Int. Cl. G06Q 20/00; G06Q 30/00; G06Q 40/00; G06Q 10/00; G06Q 50/00

(52) U.S. Cl. 705/34; 705/38; 705/40

(57) ABSTRACT

Transaction management for resource pools is facilitated. According to an example embodiment of the present invention, a transaction management approach involves the processing of transactions for different transaction parties involved with different transactions. Resources are allocated for the transactions using a pool of resources, with an associated fee assessed against one or more of the transaction parties for the allocated resource.

### RELATED PATENT DOCUMENTS

This patent document claims the benefit, under 35 U.S.C. §119(e), of U.S. Provisional Patent Application Ser. No. 61/082,433 filed on Jul. 21, 2008, and entitled “Payment Processing System and Approach with Credit Pooling;” this patent document is fully incorporated herein by reference.

### FIELD OF THE INVENTION

The present invention is directed to processing data sets and, more specifically, to a computer-based auditing and processing system that automatically processes data sets using pooled resources.

### BACKGROUND

Allocating resources for a variety of applications can be burdensome and difficult, particularly where various resources are available from different resource pools, and where the applications needing the resources vary as well. Each respective resource pool often has unique characteristics, as do the respective applications to which the resources are applied, making it difficult or impossible to assess and implement resources with applications on an application-by-application basis, particularly where a multitude of disparate applications involve unrelated conditions.

A variety of different applications involve the managing and providing of resources to suit different needs. For example, bandwidth resources applicable to the communication of data are often pooled and implemented based upon different conditions, such as those relating to the quality of service, price or the location/identity of the source and recipient for data transfer. Other applications involve the pooling of credit resources for funding financial transactions between participants, where receivables involving various disparate entities are pooled together. In gambling type applications, chips representing financial consideration are loaned for use. Energy resources, such as power grid or natural gas resources, are often pooled and delivered under varying conditions from different suppliers, often based upon the service type (e.g., continuous or variable/off-peak). In a computing environment, processing resources are often managed based upon characteristics of a processing-type of transaction (e.g., a system component vying for processing time to perform a task). In each of these applications, resources available from different pools may bear different characteristics that dictate their availability and use, which may further depend upon characteristics of the end user of the resources (e.g., communication appliance characteristics for bandwidth resources). Moreover, various resources may require delivery conditions that are unique and/or incompatible with other resources.

One exemplary application involving the management of resources relates to managing financial resources as part of the operational management of contractual and transactional interactions between buyers, sellers, financial institutions and others involved in the exchange of merchant offerings (e.g., products and/or services) for purposes of commerce. Traditional financial processing of the payment aspect of transactions typically involves a buying entity processing invoices or other payment information received from sellers. Based upon the invoices, the buying entity generates a payment in one or more of a variety of forms and provides the payment to the seller or sellers. Generally, the management of transactions between business entities has been unduly burdensome and inefficient, and has been relatively limited in providing timely and cost-effective payment in a financially secure and robust manner with relatively acceptable risk.

Conventional payment processes have been generally time consumptive and have introduced significant operational complexity. For example, a buyer typically engages in contracts with a multitude of different sellers, with each seller generally requiring different payment terms and/or processes. Where credit is extended, interaction with disparate financial institutions, credit reporting institutions, as well as payment and settlement regarding the same, is often a highly complex venture. Payment processing has thus typically involved a multitude of different functions that are performed at different times, involving different financial institutions and different sources of transaction-specific data regarding the same transaction, including user-data to facilitate the extension of credit as appropriate. For instance, payment request-type information such as that typically presented in an invoice has to be received and processed. Often, invoice processing involves several steps, including an evaluation of the transaction to ensure that the payment request information is accurate (payment should be made in accordance with the invoice), approval of the invoice and, upon approval, payment of the invoice. Further, cash flow issues for the buying entity may drive particular payment processing functions/approaches, such as those involving an extension in payment date and any corresponding fees assessed by a seller or sellers involved in the payment date change. In addition, cash flow issues for the selling entity may drive particular cash collection functions/approaches, such as those involving selling the receivable for cash at a discount in advance of receipt of the funds from the buyer and any corresponding fees and recourse requirements enforced on the seller by the entity purchasing the receivable.

In the above examples, various invoices and related activities (accounting, extension of trade credit, adjustments and others) are required for each contract and/or transaction and, where applicable, in the chain of contracts between buyer, intermediary and selling parties. These activities are time consumptive, subject to error and often duplicative or conflicting in nature. For example, the buying party may either seek financing to pay the supplier without having to come up with cash for a transaction immediately, or may decide to simply delay payment to the selling party to avoid having to come up with the cash immediately. The selling party may either seek to accelerate receipt of payment by offering inducements in the form of a discount to the buyer or may sell the receivable to a third party at a discount in return for receiving cash at an earlier date, instead of at a time when the buyer remits payment. All of these financing steps may be performed through different financial institutions, each of which is only in possession of some of the information about the transaction and this limited information leads to calculation of a higher cost of funding than if all information were available. These interactions typically involve complex agreements and associations that facilitate the transfer of funds. At times, there can be delays in payment or disputes regarding terms of payment. In addition, this process is highly susceptible to error. Interaction complexity, delay, error and a multitude of other transaction payment characteristics can cost one or more parties to a transaction a significant amount of funds.

Most industries are quite competitive and any cost savings are therefore important. Administrative costs are targeted for reduction as no revenue is directly generated from administrative functions. However, administrative costs associated with commercial transactions have been difficult to reduce in the current business environment with widely diffused data.

The above and other difficulties in the management and coordination of transactions have presented administrative and cost challenges to entities involved in various aspects of transactions. In particular, the management of payment and settlement functions with transactions involving an extension of credit to one or more transaction parties has presented operational, organizational and cost challenges.

### SUMMARY

The present invention is directed to overcoming the above-mentioned challenges and others related to the types of systems and applications discussed above (and others), as well as the various identified resources. The present invention is exemplified in a number of implementations and applications, some of which are summarized below.

According to an example embodiment, transactions between parties including transaction entities and resource-allocating institutions that sponsor the entities are processed. A database stores contract data sets for each of a multitude of contracts between the transaction entities; profile data sets for each of the transaction entities and resource-allocating institutions, the profile data including auditing rule variables for use as inputs for auditing transaction data sets; and correlation data for correlating transaction data sets with a specific contract data set for a contract between transaction entities, and with profile data sets for each of: the transaction entities and a resource-allocating institution that sponsors at least one of the transaction entities. A correlation processor uses the stored correlation data to correlate received transaction data sets with a specific contract data set and with profile data sets for each of the transaction entities and the resource-allocating institution. A computer-based auditing processor uses, for each transaction data set, the correlated contract data sets and profile data sets as inputs to audit the transaction data set to determine a condition of authorization for the transaction data set. A computer-based resource-allocation processor generates an electronic resource-allocation instruction for each transaction data set based upon the determined condition of authorization and the correlated profile data sets. A computer-based resource pool processor sources allocations, directs funds and generates fee data. Each electronic resource allocation is sourced by selecting an electronically-identified pool of resources and providing resources from the selected pool of resources based on: data characteristics of the transaction data set, term characteristics of the selected pool of resources, and resource-allocation rating data for at least one of a correlated transaction entity and resource-allocating institution. The electronic funds transfer is directed to effect settlement for resources allocated via the resource-allocation instruction. Fee data is generated to assess a fee for resources provided via the pool of resources.

According to another example embodiment of the present invention, an automated payment processing system processes payment for transactions involving buyer and seller transaction parties, with payment made to the seller from a pool of credit (i.e., the transaction is financed). Either a buyer or the financial institution that sponsors access to the pool of credit provides auditing rules defining characteristics of transactions that are acceptable for financing. Where appropriate, either the buyer or the seller provides contracts and profiles/business rules for auditing transactions involving that particular buyer/seller pairing. Payment is made to the seller party in accordance with the auditing rules and the terms of the pool of credit used to facilitate that payment by extending credit to one or both of the buyer and the seller and for which, subsequently, settlement is effected.

According to another example embodiment, an automated transaction processing system processes transactions between parties including buyers, sellers and sponsoring financial institutions. The system includes a credit pool processor to manage and implement one or more credit pools, and a transaction processor to audit and facilitate payment for transactions. The credit pool processor finances each of a multitude of transactions by, for each particular transaction, selecting and providing funds from a pool of credit as a function of a credit rating of a party to the particular transaction, data characteristics of the transaction to be financed and term characteristics of the pool of credit. The transaction processor arrangement processes transactions according to stored contract data and profile data for the buyers, sellers and sponsoring financial institutions involved in the transactions. The transaction processor includes an auditing engine, a payment processor and a fee assessment engine. The auditing engine audits each transaction involving a buyer and a seller using transaction data and profile data for at least one of the buyer and seller, and stored contract data for the transaction. The payment processor processes payment for each transaction in response to the auditing function indicating that payment is appropriate for the transaction, and the fee assessment engine assesses a transaction processing fee for transactions having payment processed therefore. The credit pool processor interacts with the transaction processor for directing funds provided via the payment processor, for directing funds to effect settlement to the pool of credit, and for assessing fees via the fee assessment engine as a function of funds provided via the pool of credit.

According to another example embodiment, a computer-implemented method involves processing transactions between parties including buyers, sellers and sponsoring financial institutions. At a credit computer, computer instructions are executed to finance each of a multitude of transactions by providing funds, for each particular transaction, from a pool of credit as a function of a credit rating of a party to the particular transaction, data characteristics of each particular transaction and term characteristics of the pool of credit. At a transaction computer, computer instructions are executed to process transactions according to stored contract data and profile data for the buyers, sellers and sponsoring financial institutions involved in the transactions. Each transaction (involving a buyer and a seller) is audited using transaction data and profile data for at least one of the buyer and seller, and stored contract data for the transaction. Payment for each transaction is processed in response to the auditing function indicating that payment is appropriate for the transaction. A transaction processing fee is assessed for transactions having payment processed therefore. Interactive information is communicated between the credit computer and the transaction computer for: directing funds provided via the payment processor, directing funds to effect settlement to the pool of credit, and assessing fees via the fee assessment engine as a function of funds provided via the pool of credit.

The above summary of the present invention is not intended to describe each illustrated embodiment or every implementation of the present invention. The figures and detailed description that follow more particularly exemplify these embodiments.

### BRIEF DESCRIPTION OF THE DRAWINGS

The invention may be more completely understood in consideration of the detailed description of various embodiments of the invention in connection with the accompanying drawings, in which:

FIG. 1A shows an arrangement and approach for processing payment for transactions via a pool of credit, according to an example embodiment of the present invention;

FIG. 1B shows an arrangement and approach for processing settlement for transactions via a pool of credit, according to another example embodiment of the present invention;

FIG. 2 shows a credit pool processor with various credit pools, according to another example embodiment of the present invention;

FIG. 3 shows an arrangement and approach for providing pool of credit-based financing for transactions sponsored or facilitated by different financial processors, according to another example embodiment of the present invention.

While the invention is amenable to various modifications and alternative forms, specifics thereof have been shown by way of example in the drawings and will be described in detail. It should be understood, however, that the intention is not necessarily to limit the invention to the particular embodiments described. On the contrary, the intention is to cover all modifications, equivalents, and alternatives falling within the spirit and scope of the invention as defined by the appended claims.

### DETAILED DESCRIPTION

The present invention is believed to be applicable to a variety of different types of transaction processing and resource management approaches, and has been found to be particularly useful for applications involving the processing of payment via the extension of credit in connection with a pool of credit. While the present invention is not necessarily limited to such approaches, various aspects of the invention may be appreciated through a discussion of various examples using these and other contexts.

According to an example embodiment of the present invention, an approach to transaction processing involves the automatic processing of payment on behalf of a transaction party in accordance with specified business rules, with the payment effected from a pool of credit resource funds from which credit is extended for the payment. In some instances, payment is processed to a seller on behalf of a buyer in accordance with business rules specified by the buyer when the payment is made from a pool of credit via the extension of credit to the buyer by a sponsoring financial institution. In other instances, payment is processed from a pool of credit to a seller as an extension of credit to the seller by a sponsoring financial institution. In either instance or in instances involving the extension of credit to both a buyer and seller, the receivable aspects of each credit extension are associated with an appropriate pool of credit.

Each extension of credit is generally processed as follows for each of the above instances. An owed party involved with a particular transaction provides transaction data such as an invoice or other request for payment. The transaction data is correlated with a transaction between a buyer and seller as well as with a financing party, and is processed in accordance with business rules associated with the correlated owing (i.e., buyer) or financing party. For instance, such processing may involve executing an algorithm with data in the transaction data set as well as with buyer business rules as variable inputs, to determine a condition of buyer authorization. Based upon the determined condition of buyer authorization, another algorithm is executed with data in the transaction data set and with business rules for the financing party to determine a condition of authorization for the extension of credit to fund the payment. Where appropriate, electronic payment is made to the owed party by the credit processor.

The receivable value of the extended payment is associated or otherwise combined with a pool of credit (receivables), which includes receivable aspects of transactions for multiple parties and, in some instances, involving multiple financial institutions that pool some or all of their funding capacity to create the pool of credit. Each of the multiple financial institutions has a stake in the receivables funded from the pool(s) of credit with which each such financial institution is associated.

When payment is received from the owing party (e.g., from the buyer), that payment is used to pay down receivables associated with the appropriate pool of credit from which credit was extended for the transaction (i.e., on behalf of the buyer and/or seller). For example, where a particular pool of credit holds receivables for multiple transactions, payment for one of the transactions is applied across the entities funding that particular pool of credit. Where an owing party fails to pay, the loss is effectively absorbed across the entities funding that particular pool of credit. Fees are assessed to at least one of the transaction parties for the transaction processing and/or the extension of credit.

Payment as described above is made to the seller on behalf of buyer (i.e., payables finance) or on behalf of the seller (i.e., receivables finance) with collection made from the buyer in either instance. For payables finance, business rules of the buyer are applied in determining a condition of payment authorization, relative to an audit or other approach. In some applications, the business rules from the seller are also applied. For receivables financing, business rules of the financial institution sponsoring payment to the seller are applied in determining a condition of payment authorization, relative to an audit or other approach. Correspondingly, in some applications, business rules from the buyer are also applied.

Fees are assessed for payments made to sellers in one or more of a variety of manners. One approach relates to business rules and, as appropriate, contract terms. For example, contracts between buyers and sellers may specify terms that, in addition to characterizing aspects of the goods and/or services to which the contract applies, characterize the assessment of fees relative to the extension of credit. For instance, in a situation where payment to seller includes a 5% hold back amount until settlement from the buyer is received, if settlement from the buyer is not received in a timely manner, the 5% hold back amount is forfeited by a party or parties agreeing to pay the fees. In some instances, the hold back amount is remitted to the pool of credit into which the settlement has been placed, or is simply kept by the financial institution sponsoring payment to the seller.

The latter portion of the aforesaid instance relating to a hold back amount and where it is applied may, for example, be processed in accordance with additional transaction information such as business rules and/or contract information pertaining to an agreement between the sponsoring financial institution and the pool of credit being accessed by the sponsoring financial institution. In this regard, a particular pool of credit may have predefined characteristics relating to these items, where participants must agree to meet such characteristics, or may involve participant-specific or transaction-specific characteristics that are defined in a contract or similar type of item that specifies participation approaches.

In some embodiments, receivables are placed into different pools of credit having different rules and/or fees based upon a credit rating of one or both of a buyer and a seller participating in a transaction to which the receivables pertain. For instance, where receivables are underwritten by a seller's financial sponsor, factors including the credit of the seller, the credit of the buyer being invoiced by the seller, the specific goods and services being sold and/or the geographic location of the buyer relative to the seller are used to place the receivables into a particular pool of credit. In this regard, entry to different pools having different rates and/or fees is obtained based upon one or more of these characteristics.

In certain embodiments involving different pools of credit, a central credit pool processor manages each pool of credit, using different criteria by which to underwrite and/or otherwise process funds transfers involving the pool of credit. For instance, where a particular pool of credit has a certain set of criteria relating to a transaction and transaction party, such as requirements relating to a transaction minimum and/or maximum amount, or to a range of credit ratings for transaction parties, the processor uses the pool of credit to fund payment for transactions meting these criteria. In this regard, the credit pool processor can set and control pools of credit and the transactions for which payment is drawn from the pool of credit.

Settlement (i.e., repayment of funds drawn from a pool of credit) is effected in a variety of manners, depending upon the application. In some applications, a buyer delivers settlement funds directly to a pool of credit processor that works with the buyer to properly apply the funds. In other embodiments, sellers provide settlement funds for receivables placed in the pool of credit. In some applications, the buyer provides settlement funds to the seller, and the seller then forwards the funds to the pool of credit processor to effect settlement with the pool of credit processor. In other applications, the seller (or the seller's financial institution) agrees to deliver settlement funds to the pool of credit processor at a particular time, regardless of whether the buyer provides the funds to the seller.

In each of the above instances, the provision of funds coming from the buyer and/or the seller need not necessarily involve a direct transfer. For example, in some instances where a seller is responsible for settlement of credit extended from a particular pool of credit, a pay-through-payment approach is implemented to automatically redirect funds, sent from the buyer to the seller, to facilitate settlement to the pool of credit. Such an approach may also effect a pay-through-payment of funds designated to a sponsoring financial institution granting access to the pool of credit, directly to the pool of credit. That is, funds designated from a buyer to a seller, and correspondingly to a sponsoring financial institution, are effectively re-routed (twice) to the pool of credit.

As consistent with the claims and the above discussion, various embodiments are directed to allocating resources for transaction entities using a pool of resources. These resources may involve one or more of a variety different types of resources, including those identified above (e.g., energy, processing time, bandwidth). The following discussion uses monetary resources in connection with multiple embodiments (e.g., extending credit based funding resources for payment), which are exemplary of various types of resource allocation. The following discussion further uses terms, such as transaction parties, buyers, sellers and others that may exemplify one or more transaction entities as discussed otherwise herein (e.g., financial institutions may exemplify resource-allocating institutions).

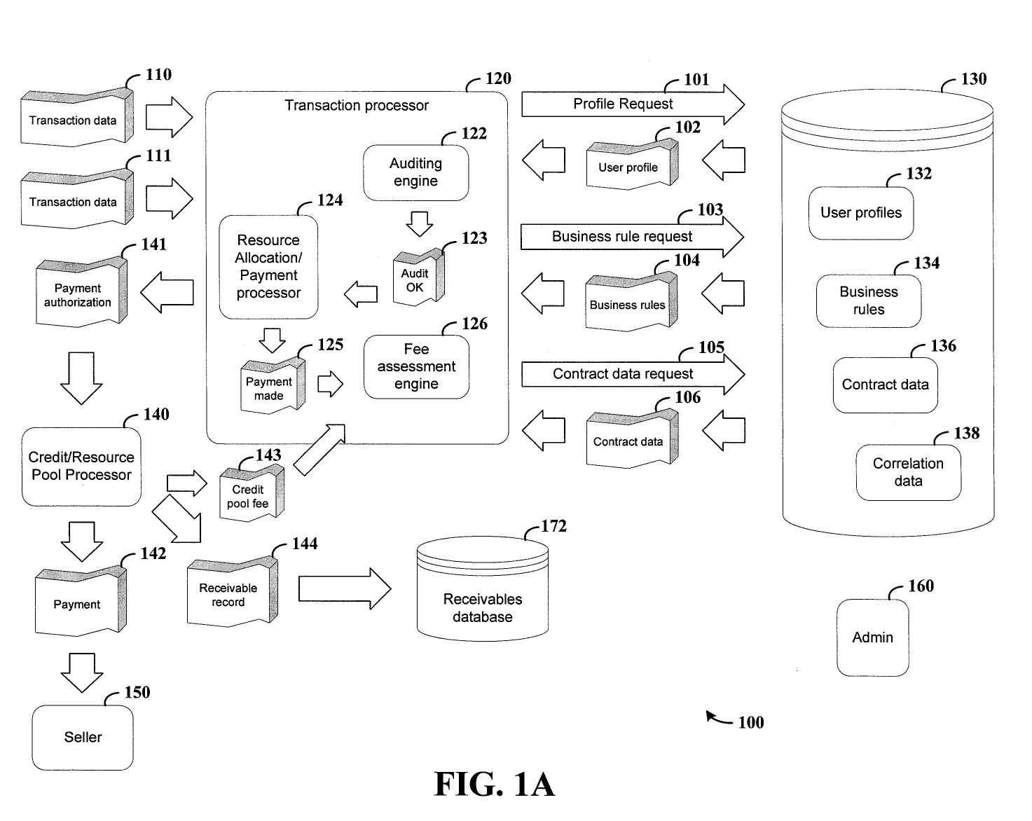

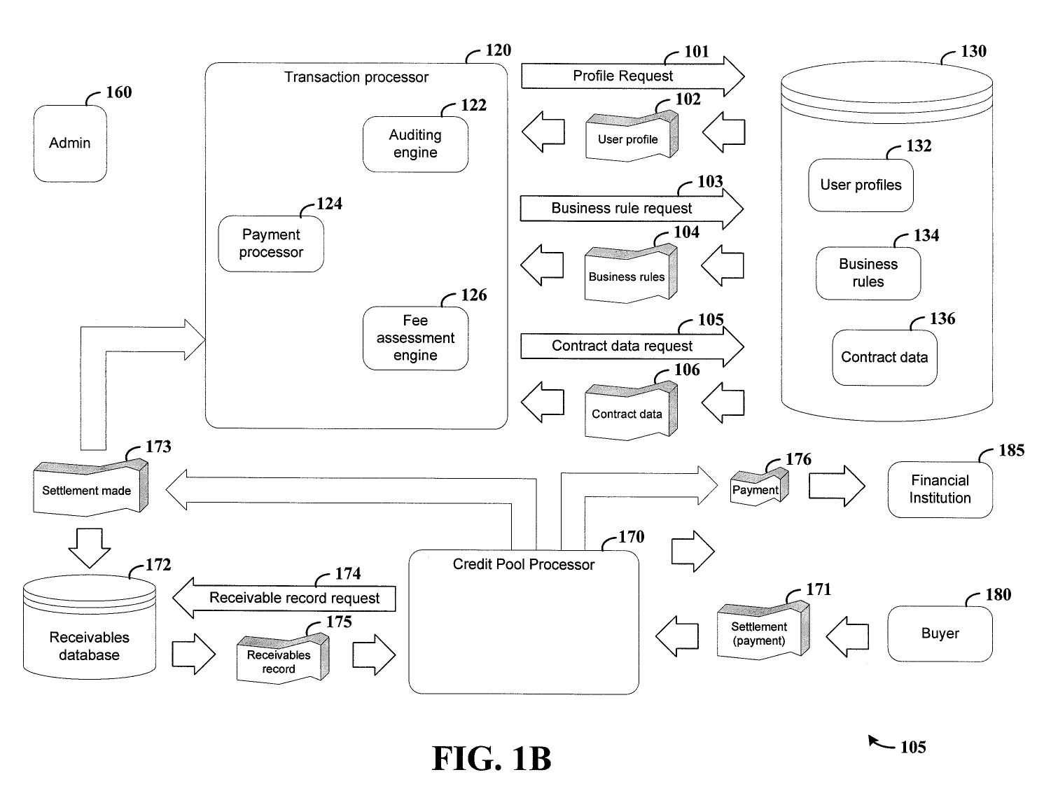

Turning now to the figures, FIG. 1A shows an arrangement and approach 100 for transaction management and payment processing, according to another example embodiment of the present invention. The system includes a transaction processor 120 that interacts with a multitude of buyers and sellers involved in different transactions, for auditing and paying transactions and, further, for facilitating the payment using one or more pools of credit. The transaction processor 120 includes an auditing engine 122, a payment processor 124 and a fee assessment engine 126, which respectively audit transactions, facilitate payment for the audited transactions and assess a fee or fees for the audited transactions.

A credit pool processor 140 (e.g., a resource pool processor) facilitates the provision of funds to effect payment to a seller or sellers for each transaction processed by the transaction processor 120, by interacting with one or more pools of credit managed and implemented, for example, using one or more approaches as described herein.

The transaction processor 120 uses data in a database arrangement 130 to process payment for transactions, interacting with the credit pool processor 140 (and/or financial institutions associated therewith) and other financial institutions associated with transaction parties to effect payment for the transactions, and to later effect settlement at an appropriate time. The database arrangement 130 stores transaction party data including user profiles 132 and business rules 134 for each transaction party, and contract data 136 corresponding to contracts between transaction parties and pertaining to transactions for which payment is processed. The database arrangement 130 also stores information that can be used to link received transaction data sets with the transaction party data and one or more contract data sets pertaining to the transaction, either as part of the aforesaid profiles and/or rules, or as separate linking data. Generally, the user profiles 132 include information corresponding to each user, specifying characteristics such as those that can be used to identify each user and/or identify one or more financial institutions for each user. The business rules 134 include user-specific information specifying rules for processing transactions, such as acceptable credit turns, payment instructions, auditing rule variables that are used as inputs to set auditing functions (e.g., audit to determine buyer acceptance or to approve credit extension), and rules corresponding to other parties with which the user (transaction party) transacts. In various contexts, the user profiles and business rules are implemented together as a common data set. The contract data 136 includes information characterizing contracts upon which transactions processed by the transaction processor 120 are based, and may include information corresponding to one or more of a specific transaction and a multitude of transactions involving particular transaction parties (e.g., buyers, sellers, financial institutions and/or credit pool-related institutions).

For general information regarding transaction processing, and for specific information regarding transaction processing approaches carried out by the administration processor 120 involving use profiles, business rules and contract data, which may be implemented in connection with one or more example embodiments described herein, reference may be made to the following patent documents, each of which is fully incorporated herein by reference: U.S. Pat. No. 5,910,896, No. 6,571,149, No. 6,697,702 and No. 6,704,612, U.S. Pat. No. 7,496,519 and U.S. Pat. No. 7,496,519, all to Hahn-Carlson.

The system 100 also includes an administrator 160 that facilitates operation of the transaction processor 120 and collects a fee for processing transactions, as assessed by the fee assessment engine 126. While shown as single arrangements, the transaction processor arrangement 120, database arrangement 130, credit pool processor 140 and the administrator 160 are selectively implemented with a common arrangement involving local and/or disparate processing devices. For example, in some embodiments, the system 100 includes a computer system that includes one or more processors that execute code to carry out the functionality described herein. Generally, the database arrangement 130 may be implemented at a common location, or across different locations and/or across different storage devices, accessible by the transaction processor 120.

When transaction data 110 such as an invoice is received at the transaction processor arrangement 120, the transaction processor makes a profile request 101 to retrieve user profile data 102 from the database arrangement 130. The user profile data 102 includes one or more user profiles associated with a buyer, seller or financial provider corresponding to the transaction data 110, and is used to identify transaction parties associated with the transaction data 110 to facilitate further processing. The requested profile is identified in one or more manners, generally using information in the transaction data 110 to identify some aspect of either a transaction or a transaction party, together with information in the database arrangement 130 to correlate the transaction data with transaction participants and a particular contract for the transaction. In some applications, the database arrangement 130 also stores correlation data 138 that includes information that, when processed by the transaction processor 120, generates data that links data necessary to audit and otherwise process payment for transactions, including contract data, profile data, business rules and any other pertinent data. This ability to correlate information together to identify contracts and transaction participants among a multitude of such contracts, participants and related transactions permits the transaction processor arrangement 120 to autonomously process transaction data sets on behalf of a multitude of disparate, unrelated parties that often operate using incompatible data systems.

Using the transaction data 110 and/or correlation data as discussed above, the transaction processor 120 (or specifically the auditing engine 122) makes a business rule request 103 and a contract data request 105 to respectively retrieve business rules 104 and contract data 106 from the database arrangement 130. These retrieved rules are used at the transaction processor 120, to generally configure the processor for operation specific to a particular transaction and/or entity to which the transaction data 110 pertains.

The auditing engine 122 audits the transaction data 110 (or other portions of the transaction to which the transaction data applies), using the user profile information 102, business rules 104 and the contract data 106 as inputs. The audit may involve, for example, using business rules 104 and information in the transaction data 110 as inputs to an algorithm to determine whether payment to a particular seller is appropriate, given information in the transaction data and, in some applications, performance data 111 characterizing performance of the transaction (e.g., buyer-provided information indicating acceptable goods and/or services). In these contexts, the audit can be effected in a multitude of manners, such as those described in the patent documents listed above in connection with the description of FIG. 1A. Accordingly, disparate (and often incompatible) data can be used by the auditing engine to respectively audit transactions in a manner that is tailored specific to each transaction.

If the audit is successful, positive audit data 123 is sent to a payment processor 124. The payment processor generates a payment authorization request 141 that is sent to a credit pool processor 140, which in turn makes a payment 142 to a seller 150 involved in the transaction (when financing audit rules are met). The credit pool processor 140 facilitates payment either directly or by interacting with a third-party financial institution specified in user profiles 102 and/or business rules 104 associated with the transaction data 110 (i.e., by sending payment authorization). Generally, the payment is facilitated based upon one or more of: data characteristics of the transaction data set to be financed, term characteristics of the selected pool of credit, and credit rating data for at least one of a correlated buyer, seller and financial institution. In certain applications, the credit pool processor 140 is associated with the transaction processor arrangement 120 (and the administrator 160), such that the transaction processor facilitates the payment 142 directly.

For each payment made, the credit pool processor 140 generates a receivables record 144 that is stored in a receivables database 172 for use in tracking receivables for subsequent settlement via collection of funds from one or more transaction parties to which the transaction data 110 applies. As is similar to the database arrangement 130, the receivables database 172 may be implemented at a common location, or across different locations and/or across different storage devices, accessible by the credit pool processor 140. Settlement is effected in a variety of manners; various settlement approaches that may be implemented with FIG. 1A are shown in FIG. 1B and described in connection therewith below.

When payment is authorized, the payment processor 124 also sends payment data 125 to a fee assessment engine 126, the payment data indicating that the payment has been authorized and that a fee is appropriate for assessment. The fee assessment engine 126 then assesses a fee against one or more parties to the transaction in accordance with one or more of user profiles, business rules and contract data associated with the transaction data 110.

In some applications, the fee assessment engine 126 responds to the payment data 125 by sending fee data to the database arrangement 130 and/or to the receivables database 172 for storage with fee data 143 for the seller 150. When payment for assessed fees is to be made, the fee assessment engine 126 applies any balance associated with the transaction party against which the fee is to be assessed, and accordingly assesses the fee. This approach may involve, for example, assessing the fee in a manner similar to that implemented with the payment authorization request 141, assessing the fee for a specific transaction via the payment authorization request 141 for that specific transaction, the fee to a receivable record in the receivables database 172, or a combination thereof.

Where fees are assessed to each payment as the payment is authorized, the fee assessment engine returns fee data directly to the payment processor 124, prior to the payment authorization request 141 being made. The payment processor 124 responds by reducing the amount of payment in the payment authorization request 141 by the amount of fee specified in the fee data. Where the fee is assessed to the seller 150, the seller is paid what it is owed for a particular transaction, less a transaction fee, with the transaction processor collecting funds in the amount of the fee from the consumer upon settlement.

Where fees are assessed to receivable records, the fee assessment engine sends fee data to the credit pool processor 140, prior to the processing of the payment authorization for credit-pool entry. The credit pool processor increases the amount of credit drawn from a credit pool, and accordingly increases any amount associated with the receivable record 144. When settlement is facilitated for the receivable record 144, the fee is accordingly assessed against the party for which the receivable record was created (e.g., against a buyer for a deferred payment, and against a seller for an early payment).

Where a credit rating of a transaction party is used in processing the transaction at one or both of the transaction processor 120 and the credit pool processor 140, external information such as credit reports are accessed and used to determine a credit rating or other information upon which the payment 142 can be made. In some applications, the credit rating is used to make a decision upon which entry into a particular pool of credit can be effected. The credit rating is generally used, for example, to characterize a particular interest rate or other financing fee, assessed via the fee assessment engine 126 or via the credit pool processor 140.

In certain embodiments, the credit pool processor 140 uses credit ratings associated with a group of transaction parties for which payment is made via a pool of credit approach. That is, rather than use specific credit ratings of individual transaction parties, a credit rating is assessed for a pool of credit associated with a group of transaction parties, with credit rates or terms assigned to individual transactions as a function of the group-based credit rating.

In another embodiment, the payment processor 124 uses information in the user profile data 102 to determine whether an interest rate or other fee associated with the payment 142 is acceptable. For example, where a particular buyer or seller is willing to draw against a credit line at credit terms up to a particular limit, the payment processor 124 authorizes payment when the auditing authorization 123 specifies terms within that particular limit for the consumer. In various embodiments, this approach is implemented similarly with the credit pool processor 140, either as with the transaction processor 120 or separately, with appropriate communications between the credit pool processor 140 and the transaction processor 120.

In still other applications, the administrator 160 obtains credit for making the payment 142 as well as other payments to a multitude of sellers, via the credit pool processor 140. That is, a credit rating associated with the administrator is used in obtaining an interest rate or other term associated with a group of receivables entered into a pool of credit. The administrator 160 agrees (via contract with a particular transaction party or otherwise) to carry auditing responsibility for credit extended on behalf of a buyer, when the transaction party (buyer, seller or other) meets certain auditing criteria. In this regard, the administrator 160's credit rating is used to obtain credit (e.g., via the credit pool processor 140). In many applications, this approach results in favorable credit terms for a particular consumer, which may be used by the administrator 160 to encourage consumers to use the transaction processor arrangement 120, with the administrator in turn earning money via fees assessed to sellers and, in some applications, via the credit terms.

In another example embodiment, the credit pool processor 140 facilitates a purchase-type transaction involving a pool of credit pertaining to other receivables, such as those associated with transactions processed elsewhere, to facilitate a self-insurance relative to collection for payments made. For instance, by purchasing a larger pool of receivables, a financial institution (or the administrator 160) providing funds for the payment 142 may reduce risk against non-payment by buyers on behalf of whom the payment 142 is made.

A more particular example embodiment that may be implemented with the system shown in FIG. 1A is as follows, for electronic transactions between parties including transaction entities and resource-allocating institutions that sponsor the entities. A database stores contract data sets for each of a multitude of contracts between the transaction entities and profile data sets for each of the transaction entities and resource-allocating institutions. The profile data includes auditing rule variables for use as inputs for auditing transaction data sets, and further includes correlation data for correlating transaction data sets with a specific contract data set for a contract between transaction entities, and with profile data sets for each of the transaction entities and a resource-allocating institution that sponsors at least one of the transaction entities. A correlation processor uses the stored correlation data to correlate received transaction data sets with a specific contract data set and with profile data sets for each of the transaction entities and the resource-allocating institution. A computer-based auditing processor uses, for each transaction data set, the correlated contract data sets and profile data sets as inputs to audit the transaction data set to determine a condition of authorization for the transaction data set. A computer-based resource-allocation processor generates an electronic resource-allocation instruction for each transaction data set based upon the determined condition of authorization and the correlated profile data sets. A computer-based resource pool processor sources allocations, directs funds and generates fee data. Each electronic resource allocation is sourced by selecting an electronically-identified pool of resources and providing resources from the selected pool of resources based on: data characteristics of the transaction data set, term characteristics of the selected pool of resources, and resource-allocation rating data for at least one of a correlated transaction entity and resource-allocating institution. The electronic funds transfer is directed to effect settlement for resources allocated via the resource-allocation instruction. Fee data is generated to assess a fee for resources provided via the pool of resources.

FIG. 1B shows an arrangement and approach 105 for processing settlement for transactions via a pool of credit, according to another example embodiment of the present invention. The approaches shown in FIG. 1B and described below may be implemented in connection with the approach shown in FIG. 1A; correspondingly, various items in FIG. 1B are labeled to correspond with FIG. 1A, with detailed discussion of these items omitted for brevity. For instance, in the processing of receivables to collect payment (settlement) for the funds associated therewith, a transaction processor 120 and/or credit pool processor 170 may implement user profiles 132, business rules 134 and contract data 136 in a similar manner to that described with FIG. 1A, with corresponding requests and return of related data shown by way of example.

When buyer 180 provides settlement funds 171 (payment) for a transaction processed by the transaction processor 120 and paid via the credit pool processor 170, the settlement funds 171 are routed to the credit pool processor. In some applications, the funds are provided directly to the credit pool processor, for example, by way of a communication made to the buyer or to the buyer's financial institution via the transaction processor 120 and profile information for the buyer during payment as with FIG. 1A. In other applications, the settlement funds 171 are routed via the transaction processor 120, either directly or by way of interaction with a particular financial institution associated with the buyer. In still other applications, the settlement funds 171 are routed by way of a seller (e.g., seller 150 in FIG. 1A) for a transaction involving the buyer 180, with the buyer providing funds to the seller which, in turn, provides the funds to the credit pool processor. In still other applications, the settlement funds 171 include funds for a multitude of transactions for which payment has been made on behalf of the buyer 180 during a particular period (e.g., a billing cycle).

In some applications, the credit pool processor 170 is associated with the transaction processor arrangement 120 (and the administrator 160), such that the transaction processor arrangement and/or the credit pool processor subsequently settles with the consumer for the payment 176 made on behalf thereof. In this regard, various aspects of the credit pool processor 140 may be implemented at the transaction processor 120, such as by programming processing functions on the transaction processor and/or with the payment processor 124.

To settle receivables, the credit pool processor 170 sends a receivable record request 174 pertaining to the settlement 171, and the receivables database 172 returns an appropriate receivables record 175. Where receivables for multiple transactions are covered by the settlement 171, the credit pool processor requests records for all of the associated transactions, and the appropriate records are returned by the receivables database 172.

Using the receivables record (or records), the credit pool processor facilitates a payment 176 to a financial institution (or other source of funds) 185 to which funds are owed in connection with a pool of credit. In this context, the financial institution 185 may host a pool of credit or otherwise buy into a pool of credit. In addition, as described above, the financial institution 185 may include one or more institutions involved with the credit pool processor 170 and/or the transaction processor 120 (and correspondingly associated with the administrator 160).

Once settlement is made, the credit pool processor 170 sends data 173 indicating that settlement is made, which is used to update the receivables database 172 to indicate that the receivable record or records have been paid, and to the transaction processor 120 as appropriate for updating any associated records. In some applications, the fee assessment engine processes a fee in accordance with the settlement at this time, and responsive to the settlement data 173, as described in connection with FIG. 1A above.

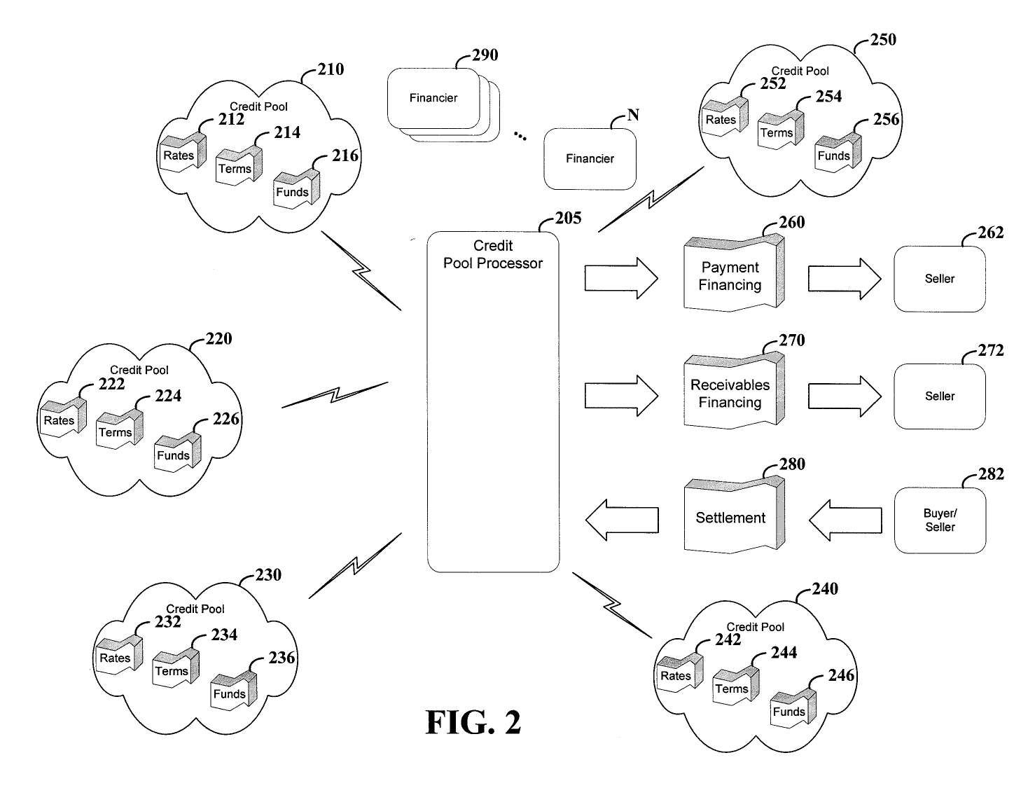

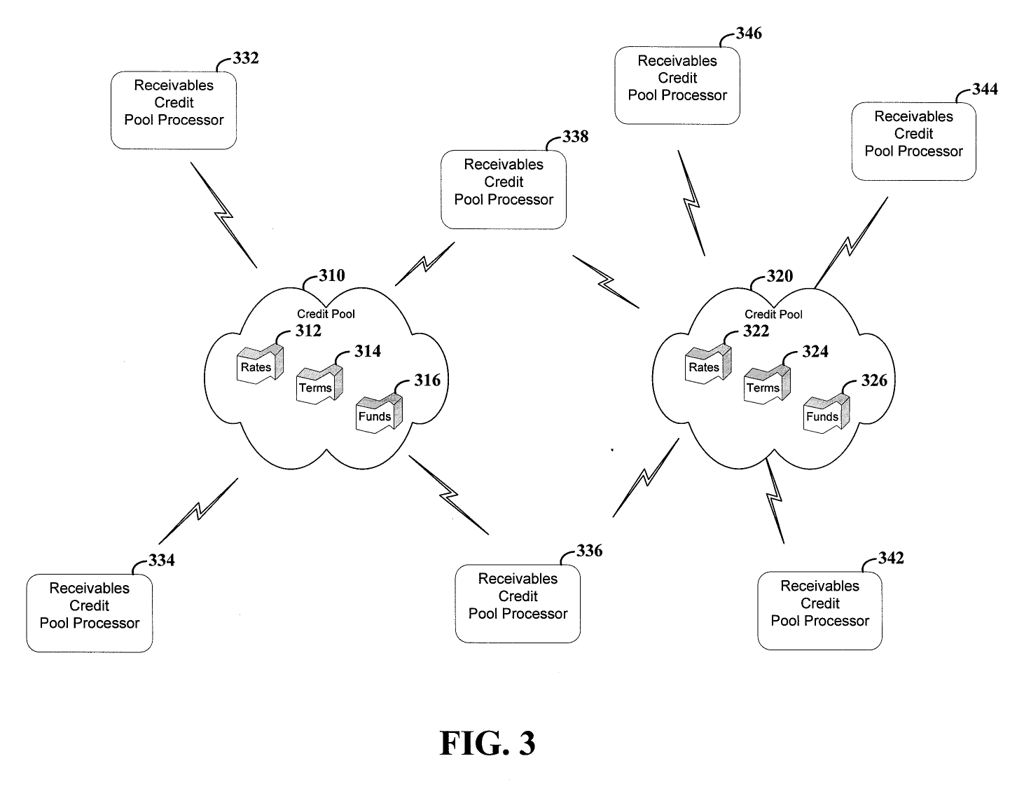

As discussed above, a variety of credit-pool approaches are implemented by one or more transaction processors, to facilitate different transactions with transaction parties having disparate business rules and credit ratings. FIG. 2 and FIG. 3 show such arrangements and approaches for providing pool of credit-based financing for transactions sponsored or facilitated by different financial processors, according to other example embodiments of the present invention. The approaches shown in FIG. 2 and in FIG. 3 may, for example, be implemented in connection with FIG. 1A and FIG. 1B; as such, various aspects corresponding to detailed transactions for which pools of credit are maintained are applicable here.

FIG. 2 shows a credit pool processor 205 that operates to process transaction funding with various credit pools 210, 220, 230, 240 and 250, according to another example embodiment of the present invention. Generally, the credit pool processor 205 may be implemented in a manner similar to that described with the credit pool processors 140 and 170 in FIG. 1A and in FIG. 1B respectively, or as a combined arrangement involving the transaction processors 120 and the credit pool processors also shown in the same figures.

The credit pool processor 205 directs funds transfers and manages receivables for a multitude of transactions involving disparate transaction parties, and further facilitates the funding of each credit pool by one more financiers 290-N. When funding for a transaction is requested, such as when a transaction processor (as in FIG. 1B) audits a transaction and determines that payment is appropriate, the credit pool processor selects a particular credit pool using transaction data, including at least a funding amount, together with profile data for a transaction party. For example, where a particular transaction and an associated transaction party meet conditions relating to funding amount, credit score and credit terms for a particular credit pool, the credit pool processor 205 selects and uses the particular credit pool from which to provide funds for payment. Where a transaction meets criteria for two or more credit pools, the credit pool processor 205 selects one of the pools using various criteria, such as by selecting a pool with desirable interest rates or other terms as may be specified in user profiles for a party to the transaction.

In certain applications, the credit pool processor 205 also uses historical data for a party to the transaction and/or of like transactions involving unrelated parties to determine a credit-based characteristic for the transaction. For instance, the credit pool processor 205 can access and use historical transaction data, such as payment timing or indebtedness, for a particular buyer (or other liable transaction party) for which transactions have been processed. Similarly, the credit pool processor 205 can use terms or other information in processed transaction data sets to identify other transactions that are similar to the transaction being processed, and to use data (such as payment timing, defaults and others) for the similar transactions to infer a condition of credit worthiness for the particular transaction for which payment is being processed.

Generally, the credit pool processor 205 provides payment financing on behalf of buyers, and receivables financing for sellers (e.g., for sellers wishing to receive early payment). For instance, the credit pool processor 205 controls payment financing for a buyer, using funds (drawdown of credit) from one or more of the credit pools 210-250, by providing payment financing funds 260 for paying a seller 262. Similarly, the credit pool processor 205 controls receivable financing for a seller 272, using funds from one or more of the credit pools 210-250 to provide receivables financing funds 270 to the seller.

For payment financing or receivables financing, when settlement funds 280 are received from a buyer or seller 282, the credit pool processor 205 provides the funds to an appropriate credit pool. The settlement funds may come directly from a buyer, such as when credit is extended to the buyer for payment financing, or when credit is extended to the seller for advance payment and collection (settlement) is made from the buyer directly. The settlement funds may come from a seller, such as when a seller finances its receivables for early payment, and subsequently provides funds to cover the receivables after receiving them from a buyer.

Where appropriate and as specified by rules, the credit pool processor 205 assesses a fee in connection with financing, to one or more of a buyer, seller or sponsoring financial party in each transaction. Such a fee may be assessed, for example, as a separate fee or by way of a withholding of certain funds as they are processed.

In these contexts, multiple participants (the “financiers”) can provide capital to fund one or more of the particular pools of credit 210-250. The credit pool processor 205 provides visibility into which transactions are being financed from the pool(s) 210-250 in which each financier participates, either on a restricted basis (e.g., protected access) or on an unrestricted basis to provide visibility to third parties. With such visibility, each financier can validate that only those transactions meeting a pool's requirements (e.g., rates 212 and terms 214) are financed from that pool, and can monitor the timeliness of settlement back to the pool from the buyer or seller.

Using the rates and terms associated with each credit pool, a financier can control and/or interact with the credit pool in various manners. For example, a financier can commit to funding up to a predefined amount of transactions that meet the pool criteria (a prospective obligation); the credit pool processor 205 then controls that credit pool to fund transactions up to such a predefined amount. A financier can also purchase receivables associated with a particular proportion of a credit pool from which payment has already been issued with the expectation that the receivables would be sold on to other financiers. For these approaches, the credit pool processor 205 carries out functions to effect control and/or access by a financier.

FIG. 3 shows a variety of receivables credit pool processors, including processors 332, 334, 336 and 338 that interact with a credit pool 310, and processors 342, 344 and 346, which interact with a credit pool 320. Receivables credit pool processors 336 and 338 each correspondingly interact with both credit pool 310 and credit pool 320. As with the credit pool processor 205 in FIG. 2, the receivables credit pool processors in FIG. 3 may also be implemented in a manner similar to that described with the credit pool processors 140 in FIG. 1A and in FIG. 1B, or as a combined arrangement involving the transaction processors 120 and the credit pool processors also shown in the same figures.

The credit pools 310 and 320 respectively implement interest rate data (312, 322) credit term data (314, 324), and available funds data (316, 326) in hosting pools of credit (receivables). In the context of FIG. 3 and these embodiments, the credit pools 310 and 320 are implemented by a financial institution or group of the same, using processing arrangements to control and execute functions related to the provision of credit and subsequent collection of funds associated with the provide credit. One or more of the credit pool processors 332, 334, 336 and 338 may control one or more of the credit pools 310 and 320 directly and/or in connection with other credit pool processors.

The receivables credit pool processors facilitate a payment from one or both of the credit pools 310 and 320 (or additional pools) by interacting with transaction data and, where appropriate, with one or more transaction processors, together with an appropriate financial institution to provide the payment to a transaction participant (e.g., seller). Receivable records are maintained for payments made from each credit pool, or as associated with each credit pool.

The credit pool processors implement terms relating to the receivable records to collect payment from an appropriate transaction party and facilitate settlement of the receivables. When settlement is received for one of the credit pools, receivables records for the settlement are updated, and any terms relating to the credit pools are correspondingly updated.

While certain aspects of the present invention have been described with reference to several particular example embodiments, those skilled in the art will recognize that many changes may be made thereto without departing from the spirit and scope of the present invention, aspects of which are set forth in the following claims.

What is claimed is:

1. An automated transaction processing system for processing transactions between parties including transaction entities and resource-allocating institutions that sponsor the entities, the system comprising:
a database that stores:
contract data sets for each of a multitude of contracts between the transaction entities,
profile data sets for each of the transaction entities and resource-allocating institutions, the profile data including auditing rule variables for use as inputs for auditing transaction data sets, and
correlation data for correlating transaction data sets with a specific contract data set for a contract between transaction entities, and with profile data sets for each of: the transaction entities and a resource-allocating institution that sponsors at least one of the transaction entities;
a correlation processor configured to use the stored correlation data to correlate received transaction data sets with a specific contract data set and with profile data sets for each of the transaction entities and the resource-allocating institution;
an auditing processor configured, for each transaction data set, to use the correlated contract data sets and profile data sets as inputs to audit the transaction data set to determine a condition of authorization for the transaction data set;
a resource-allocation processor configured to generate an electronic monetary resource-allocation instruction for each transaction data set based upon the determined condition of authorization and the correlated profile data sets; and
a computer-based monetary resource pool processor configured to
source each electronic resource allocation by selecting an electronically-identified pool of monetary resources and providing funds from the selected pool based on: data characteristics of the transaction data set, term characteristics of the selected pool of resources, and resource-allocation rating data for at least one of a correlated transaction entity and resource-allocating institution,
assign a credit term to the provided funds by executing an underwriting function with electronic credit data associated with a multitude of entities for which payment is provided via the selected pool, and
direct an electronic funds transfer to effect settlement for resources allocated via the resource-allocation instruction.

2. The system of claim 1, wherein the resource pool processor determines and assigns a credit rating to the credit-based monetary resource pool based upon a credit rating of each of the multitude of transaction entities.

3. The system of claim 1, wherein the resource pool processor obtains a credit rating associated with the monetary resource pool on a periodic basis by obtaining a credit rating based upon each of a multitude of transaction parties for which credit is to be provided, via the credit pool, for a particular period.

4. The system of claim 1, wherein the resource pool processor is configured to process a funds transfer from the monetary resource pool on a periodic basis for payments made during each period.

5. The system of claim 4, wherein the resource-allocation processor processes electronic payment to sellers on a periodic basis using the funds transferred from the monetary resource pool.

6. The system of claim 1, wherein the resource pool processor is configured, for each transaction, to interact with at least two different monetary resource pools and to provide electronic funds from one of the pools based upon credit terms associated with the pools and upon credit terms of transaction entities for which the electronic funds are provided.

7. An automated transaction processing system for processing transactions between parties including transaction entities and resource-allocating institutions that sponsor the entities, the system comprising:
a database that stores:
contract data sets for each of a multitude of contracts between the transaction entities,
profile data sets for each of the transaction entities and resource-allocating institutions, the profile data including auditing rule variables for use as inputs for auditing transaction data sets, and
correlation data for correlating transaction data sets with a specific contract data set for a contract between transaction entities, and with profile data sets for each of: the transaction entities and a resource-allocating institution that sponsors at least one of the transaction entities;
a correlation processor configured to use the stored correlation data to correlate received transaction data sets with a specific contract data set and with profile data sets for each of the transaction entities and the resource-allocating institution;
an auditing processor configured, for each transaction data set, to use the correlated contract data sets and profile data sets as inputs to audit the transaction data set to determine a condition of authorization for the transaction data set;
a resource-allocation processor configured to generate an electronic resource-allocation instruction for each transaction data set based upon the determined condition of authorization and the correlated profile data sets; and
a computer-based resource pool processor configured to
source each electronic resource allocation by selecting an electronically-identified pool of resources and providing resources from the selected pool of resources based on: data characteristics of the transaction data set, term characteristics of the selected pool of resources, and resource-allocation rating data for at least one of a correlated transaction entity and resource-allocating institution,
direct an electronic funds transfer to effect settlement for resources allocated via the resource-allocation instruction, and
generate fee data to assess a fee for resources provided via the pool of resources.

8. The system of claim 7, wherein the auditing processor is configured, for transactions involving a contracting buyer and seller and a monetary resource-allocating financial institution that sponsors one of the buyer and seller, to audit the allocation of credit-based monetary resources for providing payment to the seller on behalf of the buyer, using an underwriting approach involving credit data associated with the buyer.

9. The system of claim 7, wherein the auditing processor is configured to audit the allocation of credit-based monetary resources using an underwriting approach involving credit data associated with a selling transaction entity.

10. The system of claim 7, wherein the auditing processor is configured to audit the allocation of credit-based monetary resources using an underwriting approach involving credit data associated with both buying and selling transaction entities.

11. The system of claim 7, wherein the resource pool processor is configured, for each transaction, to interact with at least two different credit-based monetary resource pools and to provide electronic funds from one of the pools based upon data characteristics of the transaction to be financed, and of credit terms respectively associated with the pools and with at least one entity involved in the transaction.

12. The system of claim 7, wherein the resource pool processor assesses a fee for each credit-based monetary resource based upon a credit term associated with a resource pool from which monetary are provided for the transaction.

13. The system of claim 7, wherein the resource-allocation processor is configured to
generate an electronic resource-allocation instruction by generating an electronic payment instruction for each transaction data set based upon the determined condition of authorization and the correlated profile data sets, and
facilitate settlement, for funds provided from a monetary resource pool to fund the payment instruction, by providing funds to the resource pool processor in accordance with the terms of the resource pool for which settlement is being effected, along with instructions as to specific receivables that are to be cleared by the provided funds.

14. The system of claim 7, wherein the resource-allocation processor is configured to
generate an electronic resource-allocation instruction by generating an electronic payment instruction for each transaction data set in a group of transactions based upon the determined condition of authorization and the correlated profile data sets, and
facilitate settlement, for funds provided from a monetary resource pool to fund the payment instructions, by providing funds to the resource pool processor in accordance with the terms of the resource pool for which settlement is being effected, to provide collective settlement for the group of transactions.

15. The system of claim 7, wherein the resource pool processor is configured to
calculate a participation fee for a pool of resources based upon a level of risk associated with the pool and upon profile data for at least one entity participant, and
assess the fee against at least one entity according to the stored contract data and profile data.

16. The system of claim 7, wherein the respective processors are computer processors that respectively implement executable code to carry out the indicated functions of each processor.

17. The system of claim 7, wherein the resource pool processor
interacts with and controls a multitude of different pools of credit-based monetary resources, each pool having associated rules data relating to interest rates, credit terms and funding limits, and
selects and provides electronic funds from one of the pools to fund transactions based upon profile data for at least one party involved in the transaction being funded and a payment amount to be funded specified in the transaction data set.

18. A computer-implemented method for processing transactions between parties including transaction entities and resource-allocating institutions that sponsor the entities, the method comprising:
storing, in a database:
contract data sets for each of a multitude of contracts between the transaction entities,
profile data sets for each of the transaction entities and resource-allocating institutions, the profile data including auditing rule variables for use as inputs for auditing transaction data sets, and
correlation data for correlating transaction data sets with a specific contract data set for a contract between transaction entities, and with profile data sets for each of: the transaction entities and a resource-allocating institution that sponsors at least one of the transaction entities;
at a computer-based correlation processor, using the stored correlation data to correlate received transaction data sets with a specific contract data set and with profile data sets for each of the transaction entities and the resource-allocating institution;
at a computer-based auditing processor, for each transaction data set, using the correlated contract data sets and profile data sets as inputs to audit the transaction data set to determine a condition of authorization for the transaction data set;
at a computer-based resource-allocation processor, generating an electronic resource-allocation instruction for each transaction data set based upon the determined condition of authorization and the correlated profile data sets; and
at a computer-based resource pool processor,
sourcing each electronic resource allocation by selecting an electronically-identified pool of resources and providing resources from the selected pool of resources based on: data characteristics of the transaction data set, term characteristics of the selected pool of resources, and resource-allocation rating data for at least one of a correlated transaction entity and resource-allocating institution,
directing an electronic funds transfer to effect settlement for resources allocated via the resource-allocation instruction, and
generating fee data to assess a fee for resources provided via the pool of resources.
